(19) United States
(12) Patent Application Publication
(10) Pub. No.: US 2009/0216973 A1
(43) Pub. Date: Aug. 27, 2009

(54) COMPUTER SYSTEM, STORAGE SUBSYSTEM, AND DATA MANAGEMENT METHOD

(75) Inventors: Noriko NAKAJIMA, Machida (JP); Yuichi Taguchi, Sagamihara (JP); Hiroshi Nasu, Yokohama (JP); Masayuki YAMAMOTO, Sagamihara (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/174,465

(22) Filed: Jul. 16, 2008

(30) Foreign Application Priority Data
Feb. 27, 2008 (JP) 2008-045725

(51) Int. Cl. G06F 12/16; G06F 13/00

(52) U.S. Cl. 711/162; 711/E12.103

(57) ABSTRACT

To prevent, when data is erased from a storage system that stores differential of updated data, a large amount of differential data from being created, a storage subsystem provides a first storage area which stores data, and includes a second storage area which stores a replication of data stored in the first storage area. When the data stored in the first storage area is updated, the data is replicated to the second storage area before the data is updated. When a request to erase the data stored in the first storage area is received, replication of unupdated data to the second storage area is suspended and the data stored in the first storage area is erased based on the request to erase the data.

### CLAIM OF PRIORITY

The present application claims priority from Japanese application JP2008-45725 filed on Feb. 27, 2008, the content of which is hereby incorporated by reference into this application.

### BACKGROUND

This invention relates to a technology of erasing stored data from a storage subsystem.

Storage area network (SAN) is a known technology which couples at least one external storage subsystem and at least one computer. The storage area network is effective particularly when a plurality of computers share one large-scale storage subsystem. A storage system containing the storage area network is easy to add or remove a storage subsystem or a computer, and accordingly has high scalability.

Disk array devices are often commonly used as an external storage subsystem coupled to a SAN. A disk array device is equipped with a plurality of storage devices (e.g., magnetic disk devices), typically, hard disks.

A disk array device manages several magnetic disk e devices as one RAID group by a technology called redundant array of independent disks (RAID). A RAID group forms at least one logical storage area. A computer coupled to a SAN executes data input/output processing in the storage areas. When recording data in the storage areas, the disk array device records redundant data in magnetic disk devices that constitute the RAID group. The redundant data enables the disk array device to recover data even when one of the magnetic disk devices breaks down.

Data stored in the storage subsystem is backed up in case of failure. Creating a frequent backup reduces the amount of data that would be lost when a failure occurs, but backing up every piece of data at short intervals causes a heavy load on the system. As a solution, differential copy backup (copy-on-write backup) which backs up only updated data has been proposed.

The differential copy backup (copy-on-write backup) is a data backup technology in which a request made by a host computer to write in a volume triggers storing of data that has been stored in a location specified by the write request in another area. Data stored in another area is managed by the plurality of data storing time points (snapshot obtaining time points), and hence the system can be restored to states at the respective time points. The same effect can be obtained with copy-before-write backup in which write data sent from a host is written directly in a backup area.

Deduplication backup has also been proposed in order to reduce the amount of data to be replicated. The deduplication backup is a technology for avoiding, in case of backing up, redundant storing of duplicate data by recording data to be backed up only when the same data is not found in a backup area and, recording just the write location of the data in meta data without recording the data itself when the same data has already been stored in the backup area. This reduces the backup capacity compared to full data backup. Whether data has a duplicate or not is checked on a block basis, on a file basis, or the like.

Also, continuous data protection (CDP) which keeps every piece of data to be written in time series in a journal format has been proposed as a technology for enabling restoration to a state at any time point.

Data recorded in a magnetic disk device is erased by overwriting a storage area from which the data is to be erased with dummy data. However, when the data to be erased is overwritten with dummy data only once, remanent magnetism could allow the erased data to be recovered. A technology of erasing remanent magnetism completely by repeating the overwriting with dummy data at least three times has been disclosed as a solution (see JP 2007-11522 A). Erasing remanent magnetism completely and thus preventing data recovery lessen the security risk.

### SUMMARY

In a storage system that employs differential copy, processing of overwriting with dummy data for erasing data causes differential copy of a huge quantity of data to be executed, and accordingly increases the load on the system. Another problem is that storing the differential data requires a backup area that has a large capacity.

According to a representative invention disclosed in this application, there is provided a computer system, including: a storage subsystem which stores data read and written by a host computer; and a management computer which has access to the storage subsystem. The storage subsystem includes a first interface coupled to the host computer, a first processor coupled to the first interface, and a first memory coupled to the first processor, provides a first storage area which stores the data, and includes a second storage area which stores a replication of the data stored in the first storage area. The management computer includes a second interface coupled to the storage subsystem, a second processor coupled to the second interface, and a second memory coupled to the second processor. When the data stored in the first storage area is to be updated, the storage subsystem replicates unupdated data to the second storage area. Upon reception of a request to erase the data stored in the first storage area, the management computer sends the request to erase the data stored in the first storage area to the storage subsystem. And the storage subsystem suspends the replication of the unupdated data to the second storage area upon reception of the request to erase the data stored in the first storage area, and erases the data stored in the first storage area based on the request to erase the data. According to an aspect of this invention, a large amount of differential copy data created by erasing data from a storage area where differential copy is executed can be prevented from increasing the load on the system.

### BRIEF DESCRIPTION OF THE DRAWINGS

The present invention can be appreciated by the description which follows in conjunction with the following figures, wherein:

FIG. 1 is a diagram showing a configuration of a storage area network according to a first embodiment of this invention;

FIG. 2 is a diagram showing a configuration of a storage subsystem according to the first embodiment of this invention;

FIG. 3 is a diagram showing a configuration of a host computer according to the first embodiment of this invention;

FIG. 4 is a diagram showing a configuration of a backup server according to the first embodiment of this invention;

FIG. 5 is a diagram showing a configuration of a management computer according to the first embodiment of this invention;

FIG. 6 is a diagram showing an example of a logical storage area configuration information which is stored in the storage subsystem according to the first embodiment of this invention;

FIG. 7 is a diagram showing an example of a logical storage unit configuration information that is stored in the storage subsystem according to the first embodiment of this invention;

FIG. 8 is a diagram showing an example of a backup pool path configuration information which is stored in the storage subsystem according to the first embodiment of this invention;

FIG. 9 is a diagram showing an example a the backup pool configuration information which is stored in the storage subsystem according to the first embodiment of this invention;

FIG. 10 is a diagram showing an example of a backup data storage location information which is stored in the storage subsystem according to the first embodiment of this invention;

FIG. 11 is a diagram showing an example of a snapshot configuration information that is stored in the storage subsystem according to the first embodiment of this invention;

FIG. 12 is a diagram showing an example of a external connection configuration mapping information which is stored in the storage subsystem according to the first embodiment of this invention;

FIG. 13 is a diagram showing an example of a host computer storage volume configuration information which is stored in the host computer according to the first embodiment of this invention;

FIG. 14 is a diagram showing an example of a configuration of a storage system according to the first embodiment of this invention;

FIG. 15 is a flow chart showing steps of allocating a logical storage area to a backup virtual storage area pool in backup virtual storage area pool creating processing according to the first embodiment of this invention.

FIG. 16 is a flow chart showing steps of allocating a logical storage unit to be backed up to a backup virtual storage area pool in the backup virtual storage area pool creating processing according to the first embodiment of this invention;

FIG. 17 is a flow chart showing steps of writing data in a logical storage area in the storage subsystem according to the first embodiment of this invention;

FIG. 18 is a flow chart showing steps of processing of updating the snapshot configuration information that is stored in the storage subsystem according to the first embodiment of this invention;

FIG. 19 is a flow chart showing steps of snapshot restoration processing in the storage subsystem according to the first embodiment of this invention;

FIG. 20 is a flow chart showing steps of processing of erasing data from a logical storage area in the storage subsystem according to the first embodiment of this invention;

FIG. 21 is a diagram showing an example of information output on an erasure certificate according to the first embodiment of this invention;

FIG. 22 is a diagram showing an example of the backup data storage location information after the data erasure processing according to the first embodiment of this invention;

FIG. 23 is a diagram showing an example of the snapshot configuration information after the data erasure processing according to the first embodiment of this invention;

FIG. 24 is a flow chart showing steps of backup processing in the storage subsystem according to the second embodiment of this invention; and

FIG. 25 is a flow chart showing steps of processing of erasing data from a logical storage area in the storage subsystem according to the second embodiment of this invention.

### DETAILED DESCRIPTION OF THE PREFERRED EMBODIMENTS

Embodiments of this invention will be described below with reference to the accompanying drawings.

### First Embodiment

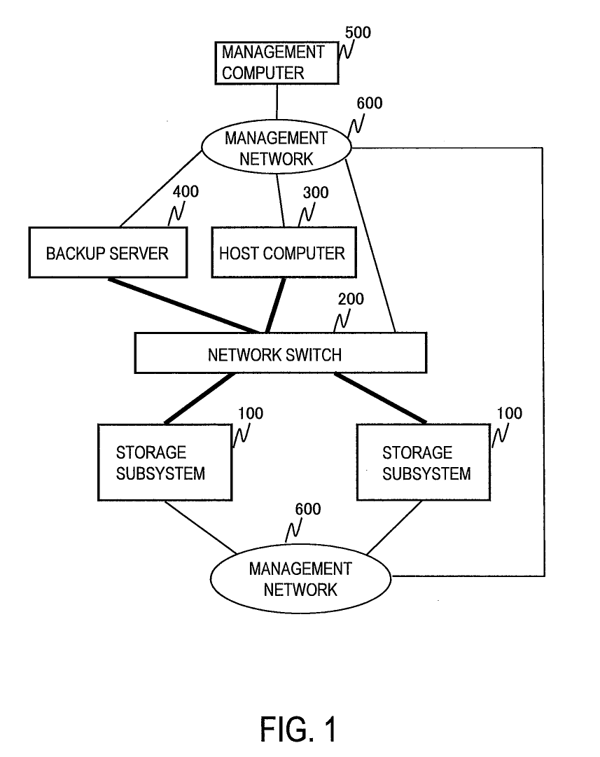

FIG. 1 is a diagram showing a configuration of a storage area network according to a first embodiment of this invention. The storage area network includes a data input/output network and a management network 600.

The data input/output network contains a storage subsystem 100, a network switch 200, a host computer 300, and a backup server 400. The host computer 300 and the storage subsystem 100 are intercoupled via the network connector 200, and hence data is input to and output from each other. The data input/output network is represented by the bold line in FIG. 1. The data input/output network is fibre channel, Ethernet (registered trademark, hereinafter, Ethernet®), or other networks of prior art.

The management network 600 is a network of prior art, such as Fibre Channel or Ethernet. The storage subsystem 100, the network switch 200, the host computer 300, and the backup server 400 couples to a management computer 500 via the management network 600.

In the host computer 300, a database, a file server, or a similar application runs, and data input/output in storage areas is executed. The storage subsystem 100 is equipped with storage devices such as magnetic disk devices, that provides storage areas for data read/written by the host computer 300. The backup server 400 executes a snapshot restoration request in order to restore data stored in the storage subsystem 100. The network connector 200 is equipment that couples the host computer 300, the storage subsystem 100, and the backup server 400. A Fibre Channel switch, for example, is employed as the network connector 200.

The management network 600 and the data input/output network, which, in the first embodiment, are separate networks independent of each other, may be a single network that has the functions of both.

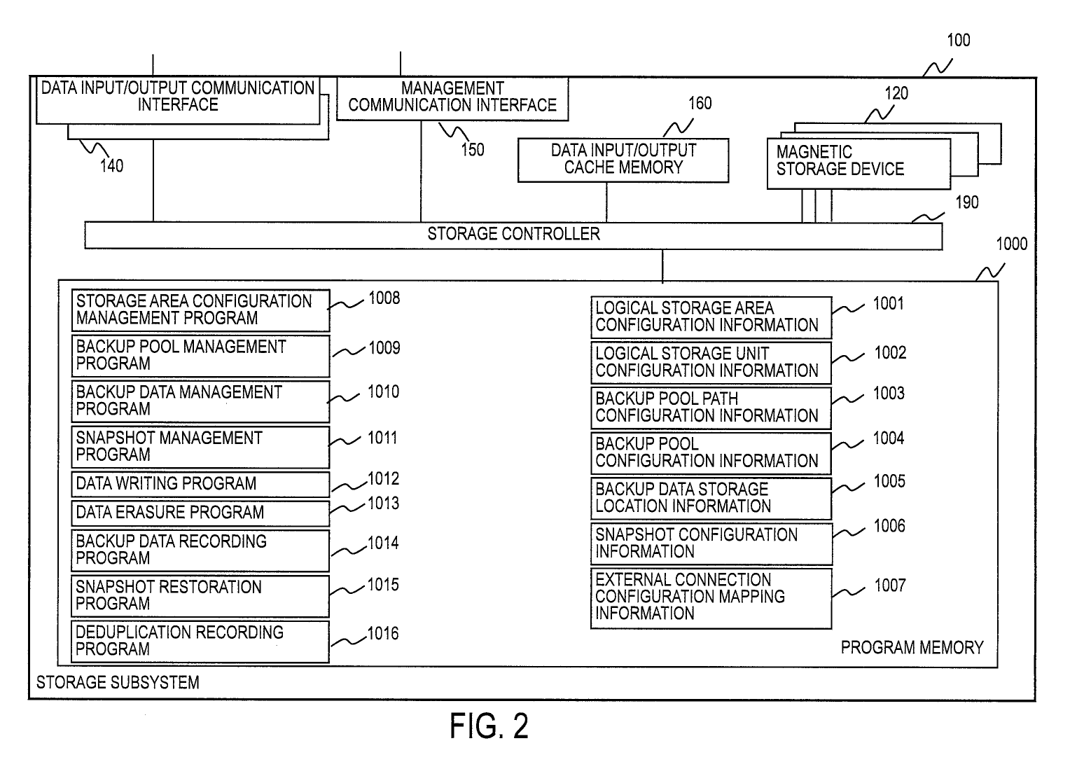

FIG. 2 is a diagram showing the configuration of the storage subsystem 100 according to the first embodiment of this invention.

The storage subsystem 100 contains a data input/output communication interface 140, a management communication interface 150, a storage controller 190, a program memory 1000, a data input/output cache memory 160, and magnetic disk devices 120. The data input/output communication interface 140, the management communication interface 150, the program memory 1000, the data input/output cache memory 160, and the magnetic disk devices 120 are coupled to one another through the storage controller 190.

The data input/output communication interface 140 couples to the network connector 200 over the data input/output network. The management communication interface 150 couples to the management computer 500 over the management network 600. The storage subsystem 100 can have an arbitrary number of data input/output communication interfaces 140 and management communication interfaces 150. The data input/output communication interface 140 may not necessarily be a separate component from the management communication interface 150, and management information may be input/output through the data input/output communication interface 140 so that the data input/output communication interface 140 serves also as the management communication interface 150.

The storage controller 190 is equipped with a processor that controls the storage subsystem 100. The data input/output cache memory 160 is a temporary storage area which speeds up data input/output access to storage areas from the host computer 300. The data input/output cache memory 160 is commonly constituted of a volatile memory, but a non-volatile memory or a magnetic disk device can substitute for a volatile memory as the data input/output cache memory 160. The number and capacity of the data input/output cache memory 160 are not limited. The magnetic disk devices 120 store data read/written by the host computer 300.

The program memory 1000 stores programs and control information necessary for processing that is executed in the storage subsystem 100. The program memory 1000 is constituted of a magnetic disk device or a semiconductor memory. Control programs and control information stored in the program memory 1000 will be described below.

The control programs stored in the program memory 1000 include a storage area configuration management program 1008, a backup pool management program 1009, a backup data management program 1010, a snapshot management program 1011, a data writing program 1012, a data erasure program 1013, a backup data recording program 1014, a snapshot restoration program 1015, and a deduplication recording program 1016.

The storage area configuration management program 1008 manages the attributes of logical storage units and of logical storage areas. The storage area configuration management program 1008 defines an LU path for a command from the host computer 300, and controls the association of a logical storage area with a logical storage unit.

The backup pool management program 1009 is a program that manages the allocation of logical storage areas to a backup virtual storage area pool. The backup pool management program 1009 also controls the association between a logical storage unit and a backup virtual storage area pool.

The backup data management program 1010 controls the association between the address of a logical storage area that is associated with a logical storage unit and that is the copy source of backup data and the address of a logical storage area that is associated with a backup virtual storage area pool. The backup data management program 1010 also controls the association between the address of a logical storage area and snapshot identification information.

The snapshot management program 1011 is a program that updates the snapshot identification information of a logical storage unit at one time point. The data writing program 1012 is a program that writes data in storage areas.

The data erasure program 1013 is a program that erases stored data completely from a storage area to be erased by overwriting the entire storage area with dummy data. For logical storage areas constituting a backup virtual storage area pool, the data erasure program 1013 specifies on a block basis an area from which data is to be erased, and executes complete data erasure.

The backup data recording program 1014 is a program that reads data out of a backup copy source logical storage area and writes the backup data in a backup copy destination logical storage area.

The snapshot restoration program 1015 is a program that executes snapshot restoration by making a replication of a logical storage unit to be restored upon reception of a restoration request and copying backup data that covers a time period between the reception of the request and a restoration time point to this logical storage unit.

The deduplication recording program 1016 is a program that judges whether or not duplicate data has been stored in a logical storage area that is recorded in backup data storage location information 1005.

The control information stored in the program memory 1000 includes logical storage area configuration information 1001, logical storage unit configuration information 1002, backup pool path configuration information 1003, backup pool configuration information 1004, the backup data storage location information 1005, snapshot configuration information 1006, and external connection configuration mapping information 1007.

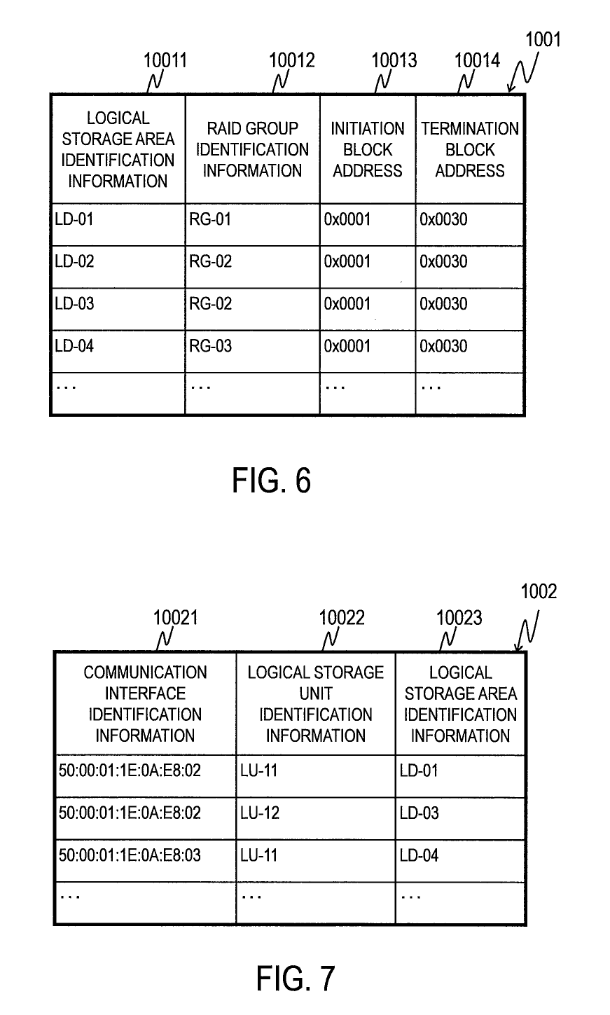

The logical storage area configuration information 1001 is the configuration information of a storage area that is obtained by logically partitioning a RAID group and that is used as the unit of storage resource. Details of the logical storage area configuration information 1001 will be described later with reference to FIG. 6.

The logical storage unit configuration information 1002 is the configuration information of a logical storage unit, which is the unit of storage resource provided to the host computer 300. Details of the logical storage unit configuration information 1002 will be described later with reference to FIG. 7.

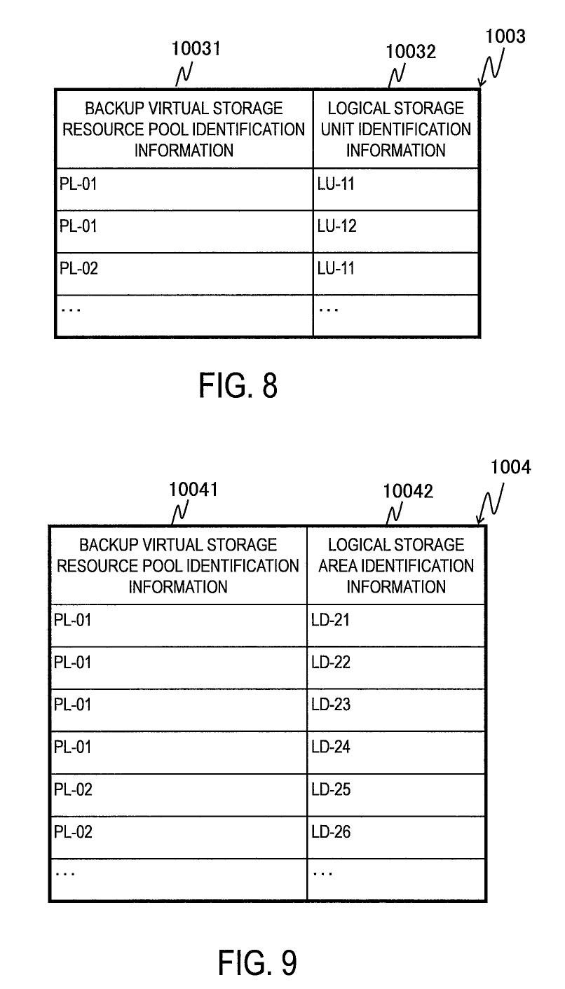

The backup pool path configuration information 1003 holds the correspondence relation between a backup virtual storage area pool and a logical storage unit. Details of the backup pool path configuration information 1003 will be described later with reference to FIG. 8.

The backup pool configuration information 1004 holds the correspondence relation between a backup virtual storage area pool and a logical storage area. Details of the backup pool configuration information 1004 will be described later with reference to FIG. 9.

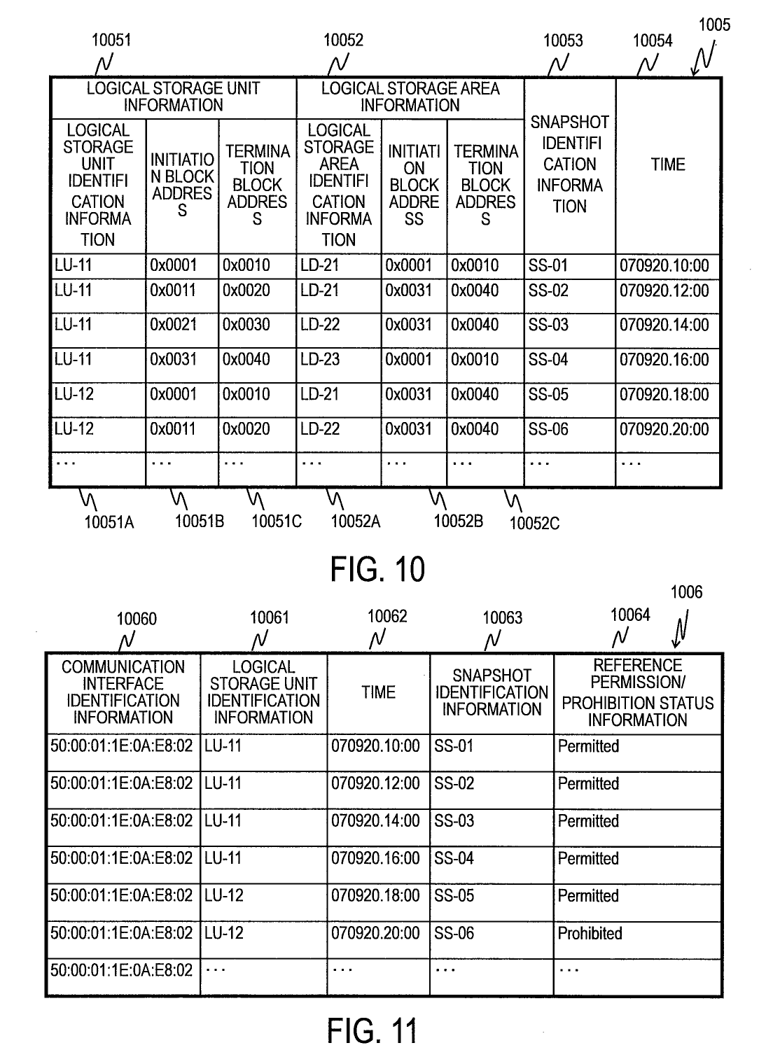

The backup data storage location information 1005 is information about the storage destination of backup data of data stored in a logical storage unit. Details of the backup data storage location information 1005 will be described later with reference to FIG. 10.

The snapshot configuration information 1006 is information about a snapshot of differential data of data stored in a logical storage unit. Details of the snapshot configuration information 1006 will be described later with reference to FIG. 11.

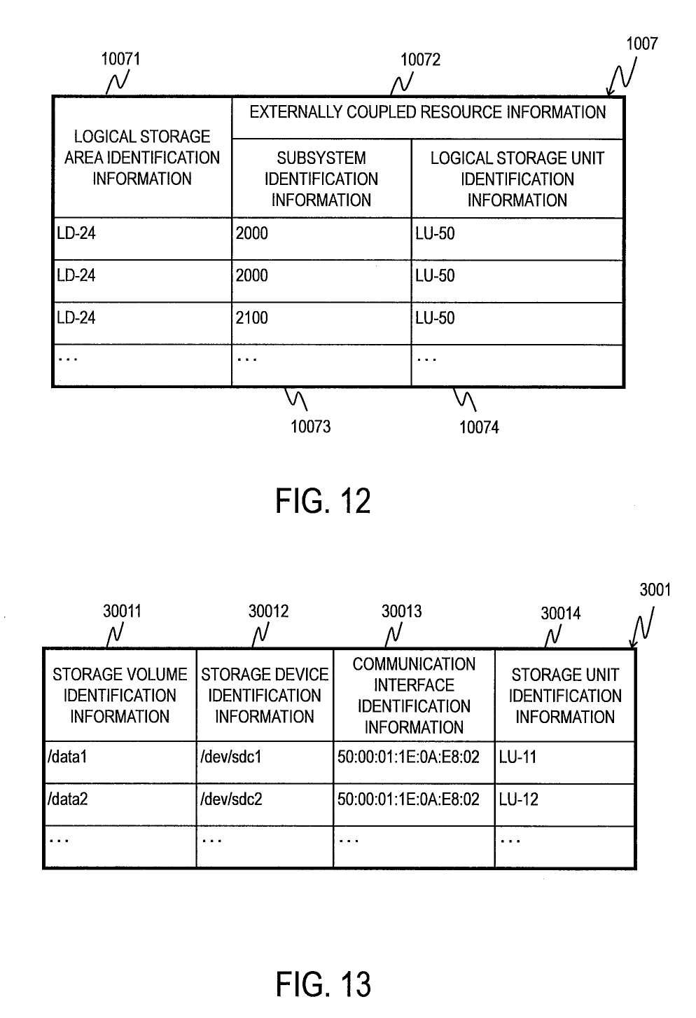

The external connection configuration mapping information 1007 holds the correspondence between a logical storage area and an external logical storage unit. Details of the external connection configuration mapping information 1007 will be described later with reference to FIG. 12.

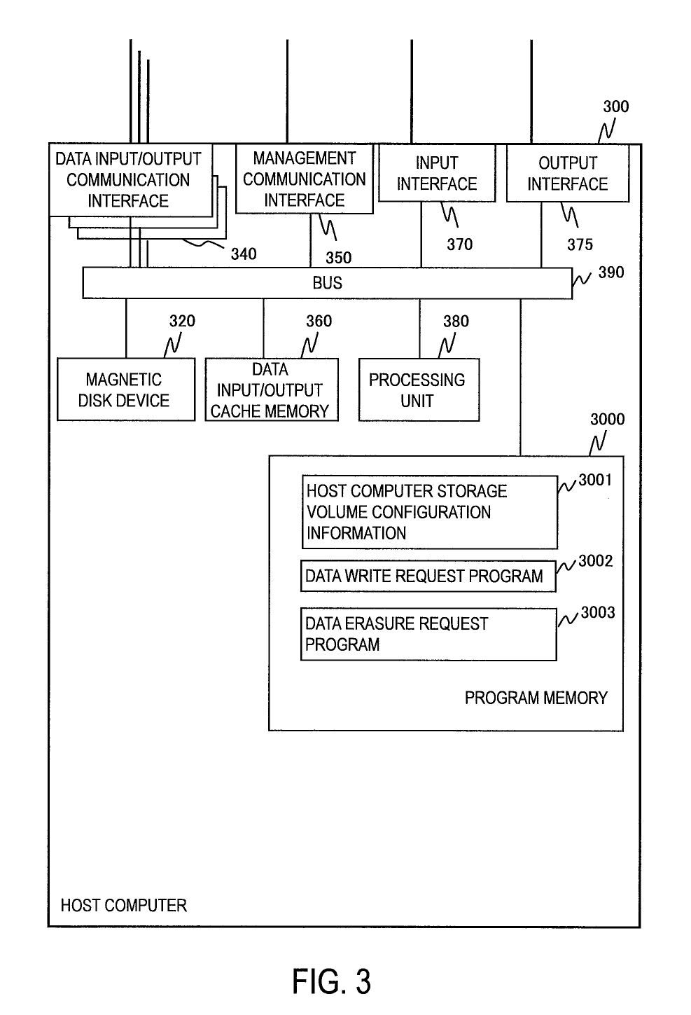

FIG. 3 is a diagram showing the configuration of the host computer 300 according to the first embodiment of this invention.

The host computer 300 contains a data input/output communication interface 340, a management communication interface 350, an input interface 370, an output interface 375, a processing unit 380, a magnetic disk device 320, and a data input/output cache memory 360.

The data input/output communication interface 340, the management communication interface 350, the input interface 370, the output interface 375, the processing unit 380, the magnetic disk device 320, and the data input/output cache memory 360 are coupled to one another via a communication bus 390. The hardware configuration of the host computer 300 can be implemented in a general-purpose computer (PC).

The data input/output communication interface 340 couples to the network connector 200 over the data input/output network to input/output data. The management communication interface 350 couples to the management computer 500 over the management network 600 to input/output management information. The host computer 300 can have an arbitrary number of data input/output communication interfaces 340 and management communication interfaces 350. The data input/output communication interface 340 may not necessarily be a separate component from the management communication interface 350, and management information may be input/output through the data input/output communication interface 340 so that the data input/output communication interface 340 serves also as the management communication interface 350.

The input interface 370 couples to equipment with which a user enters information, for example, a keyboard and a mouse. The output interface 375 couples to equipment through which information is output to the user, for example, a general-purpose display. The processing unit 380 executes various computations, and corresponds to a CPU or a processor. The magnetic disk device 320 stores software such as an operating system and an application.

The data input/output cache memory 360 is constituted of a volatile memory or the like, and is used to speed up input and output of data to and from the magnetic disk device 320. Although the data input/output cache memory 360 is implemented commonly by a volatile memory, a non-volatile memory or a magnetic disk device may be employed instead. The number and capacity of the data input/output cache memory 360 are not limited.

The program memory 3000 stores programs and control information necessary for processing that is executed in the host computer 300. The program memory 3000 is constituted of a magnetic disk device or a semiconductor memory. Control programs and control information stored in the program memory 3000 will be described below.

The program memory 3000 stores host computer storage volume configuration information 3001, a data write request program 3002, and a data erasure request program 3003.

The host computer storage volume configuration information 3001 holds information of storage devices mounted to the host computer 300. Details of the host computer storage volume configuration information 3001 will be described later with reference to FIG. 13.

The data write request program 3002 is a program that determines in which host computer storage volume data is to be written, and sends a write request message to a logical storage unit in the storage subsystem 100 that is associated with the determined storage volume through the data input/output communication interface 140 of this storage subsystem 100.

The data erasure request program 3003 is a program that determines from which host computer storage volume data is to be erased, and sends a data erasure request message to a logical storage unit in the storage subsystem 100 that is associated with the determined storage volume through the data input/output communication interface 140 of this storage subsystem 100.

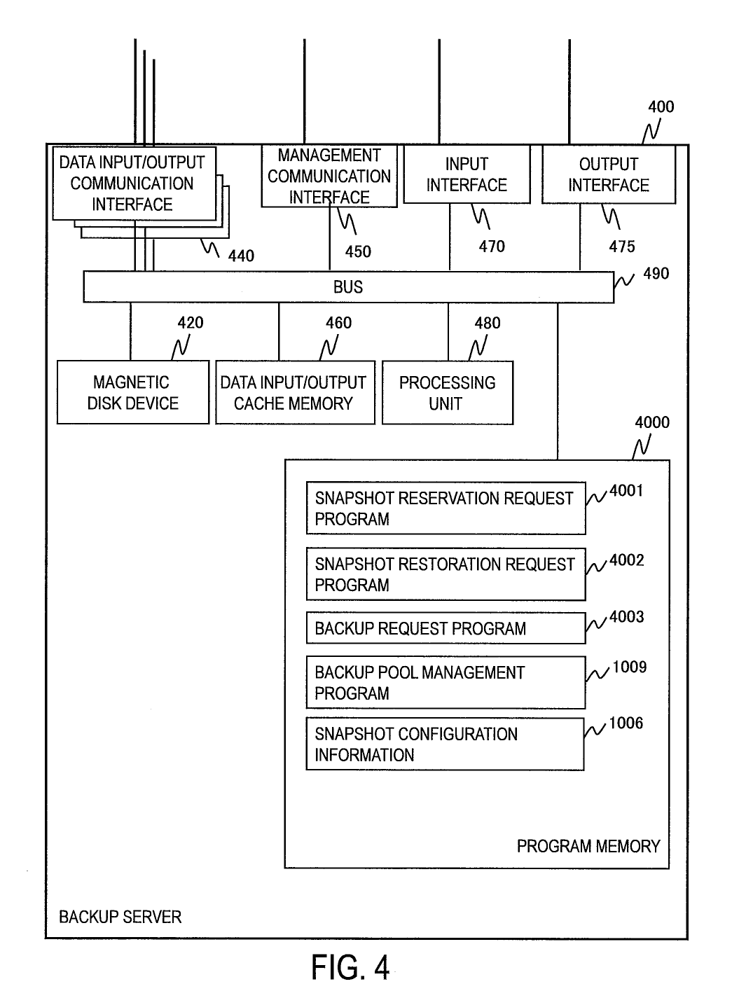

FIG. 4 is a diagram showing the configuration of the backup server 400 according to the first embodiment of this invention.

The backup server 400 contains a data input/output communication interface 440, a management communication interface 450, an input interface 470, an output interface 475, a processing unit 480, a magnetic disk device 420, a program memory 4000, and a data input/output cache memory 460.

The data input/output communication interface 440, the management communication interface 450, the input interface 470, the output interface 475, the processing unit 480, the magnetic disk device 420, the program memory 4000, and the data input/output cache memory 460 are coupled to one another via a communication bus 490. The hardware configuration of the backup server 400 can be implemented in a general-purpose computer (PC). The functions of the components of the backup server 400 are the same as in the host computer 300 shown in FIG. 3.

The program memory 4000 stores programs and control information necessary for processing that is executed in the backup server 400. Control programs and control information stored in the program memory 4000 will be described below.

The program memory 4000 stores a snapshot reservation request program 4001, a snapshot restoration request program 4002, a backup request program 4003, the backup pool management program 1009, and the snapshot configuration information 1006.

The snapshot reservation request program 4001 is a program that sends an update request to the snapshot configuration information 1006 of the storage subsystem 100. When the requested update succeeds, the snapshot configuration information 1006 that is stored in the backup server 400 is updated.

The snapshot restoration request program 4002 is a program that sends a snapshot restoration request to the storage subsystem 100.

The backup request program 4003 is a program that sends a data backup request to the storage subsystem 100.

The backup pool management program 1009 is a program that inputs a logical storage unit to be copied for backup to the storage subsystem 100 in order to create a backup virtual storage area pool which is a backup copy destination.

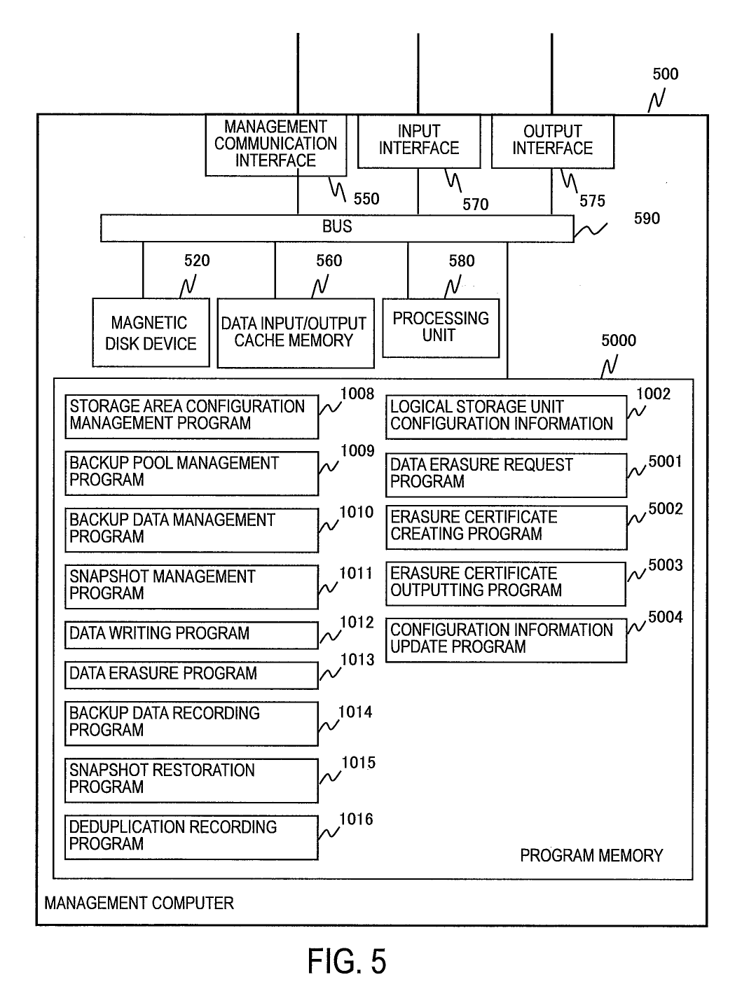

FIG. 5 is a diagram showing the configuration of the management computer 500 according to the first embodiment of this invention.

The management computer 500 contains a management communication interface 550, an input interface 570, an output interface 575, a processing unit 580, a magnetic disk device 520, a program memory 5000, and a data input/output cache memory 560.

The management communication interface 550, the input interface 570, the output interface 575, the processing unit 580, the magnetic disk device 520, the program memory 5000, and the data input/output cache memory 560 are coupled to one another via a communication bus 590. The hardware configuration of the management computer 500 can be implemented in a general-purpose computer (PC). The functions of the components of the management computer 500 are the same as in the host computer 300 shown in FIG. 3.

The program memory 5000 stores programs and information necessary for processing that is executed in the management computer 500. Control programs and control information stored in the program memory 5000 will be described below.

The control programs stored in the program memory 5000 include a data erasure request program 5001, an erasure certificate creating program 5002, an erasure certificate outputting program 5003, a configuration information update program 5004, the storage area configuration management program 1008, the backup pool management program 1009, the backup data management program 1010, the snapshot management program 1011, the data writing program 1012, the data erasure program 1013, the backup data recording program 1014, the snapshot restoration program 1015, and the deduplication recording program 1016. The control information stored in the program memory 5000 includes the logical storage unit configuration information 1002.

The data erasure request program 5001 is a program that determines from which logical storage unit or logical storage area data is to be erased, and sends a data erasure request to the logical storage unit or the logical storage area within the storage subsystem 100.

The erasure certificate creating program 5002 is a program that creates an erasure certificate upon reception of information indicating that data has been erased from the storage subsystem 100.

The erasure certificate outputting program 5003 is a program that outputs a crated erasure certificate.

The configuration information update program 5004 is a program that updates the logical storage unit configuration information 1002 of the management computer 500 by reflecting the logical storage unit configuration information 1002 that is received from the storage subsystem 100.

FIG. 6 is a diagram showing an example of the logical storage area configuration information 1001 which is stored in the storage subsystem 100 according to the first embodiment of this invention.

The logical storage area configuration information 1001 contains logical storage area identification information 10011, RAID group identification information 10012, an initiation block address 10013, a termination block address 10014.

The logical storage area identification information 10011 is an identifier by which a logical storage area is identified. The RAID group identification information 10012 is an identifier by which a RAID group is identified. A storage area identified by the logical storage area identification information 10011 is a logical storage area defined to belong to a RAID group that is identified by the RAID group identification information 10012.

The initiation block address 10013 is the initiation block address of a physical area in which a storage area that is identified by the logical storage area identification information 10011 is stored. The termination block address 10014 is the termination block address of a physical area in which a storage area that is identified by the logical storage area identification information 10011 is stored.

FIG. 7 is a diagram showing an example of the logical storage unit configuration information 1002 that is stored in the storage subsystem 100 according to the first embodiment of this invention.

The logical storage unit configuration information 1002 holds the correspondence among a communication interface, a storage unit which is the unit of storage resource accessible from the host computer 300, and a storage area.

The logical storage unit configuration information 1002 contains communication interface identification information 10021, storage unit identification information 10022, and storage area identification information 10023.

The communication interface identification information 10021 is an identifier for uniquely identifying the data input/output communication interface 140 of each storage subsystem 100. For example, world wide name (WWN) is stored as the communication interface identification information 10021.

The storage unit identification information 10022 is an identifier for uniquely identifying each storage unit. The storage unit is the unit of storage resource accessible from the host computer 300 which is coupled to the storage unit 100, and corresponds to a volume mounted to a file system that is run by the host computer 300.

The storage area identification information 10023 is an identifier for uniquely identifying each logical storage area provided by the storage subsystem 100.

FIG. 8 is a diagram showing an example of the backup pool path configuration information 1003 which is stored in the storage subsystem 100 according to the first embodiment of this invention.

The backup pool path configuration information 1003 holds the relation on correspondence between a backup virtual storage area pool and a logical storage unit as described above. The backup pool path configuration information 1003 contains backup virtual storage resource pool identification information 10031 and logical storage unit identification information 10032.

The backup virtual storage resource pool identification information 10031 is an identifier by which a backup virtual storage area pool is identified. The logical storage unit identification information 10032 is the identifier of a logical storage unit.

Backup data in a logical storage unit that is identified by the logical storage unit identification information 10032 is stored in a backup virtual storage area pool that is identified by the backup virtual storage resource pool identification information 10031 with the use of the backup pool path configuration information 1003.

FIG. 9 is a diagram showing an example of the backup pool configuration information 1004 which is stored in the storage subsystem 100 according to the first embodiment of this invention.

The backup pool configuration information 1004 holds the relation on correspondence between a backup virtual storage area pool and a logical storage area. The backup pool configuration information 1004 contains backup virtual storage resource pool identification information 10041 and logical storage area identification information 10042.

The backup virtual storage resource pool identification information 10041 is an identifier by which a backup virtual storage area pool is identified. The storage area identification information 10042 is the identifier of a logical storage area. A backup virtual storage area pool recorded as the backup virtual storage resource pool identification information 10041 is a group of storage areas constituted of logical storage areas that are recorded as the logical storage area identification information 10042.

FIG. 10 is a diagram showing an example of the backup data storage location information 1005 which is stored in the storage subsystem 100 according to the first embodiment of this invention.

The backup data storage location information 1005 contains logical storage unit information 10051, logical storage area information 10052, snapshot identification information 10053, and a time 10054.

The logical storage unit information 10051 is information that expresses, by address, a portion of the storage area of a logical storage unit registered in a backup pool. The logical storage unit information 10051 contains logical storage unit identification information 10051A, an initiation block address 10051B, and a termination block address 10051C.

The logical storage unit identification information 10051A is an identifier by which a logical storage unit is identified. The initiation block address 10051B and the termination block address 10051C are addresses indicating where the logical storage unit identified by the logical storage unit identification information 10051A is stored.

The logical storage area information 10052 is information indicating a physical storage area that actually stores backup data recorded in a storage area space that is identified from the logical storage unit information 10051. The logical storage area information 10052 contains logical storage area identification information 10052A, an initiation block address 10052B, and a termination block address 10052C.

The logical storage area identification information 10052A is an identifier by which a logical storage area is identified. The initiation block address 10052B and the termination block address 10052C are addresses indicating where the logical storage area identified by the logical storage area identification information 10052A is stored.

The snapshot identification information 10053 is an identifier by which a snapshot constituting backup data is identified. The time 10054 is a time when a snapshot identified by the snapshot identification information 10053 is obtained. From the snapshot identification information 10053 and the time 10054, data is identified as backup data of a logical storage unit identified by the logical storage unit identification information 10051A at the obtained time point.

For example, FIG. 10 shows that a snapshot “SS-01” obtained at the time point “070920 10:00” as backup data of data that has been recorded in a logical storage unit “LU-11” from a block address “0x0001” to a block address “0x0010” is recorded in a logical storage area “LD-21” from a block address “0x0001” to a block address “0x0010”.

FIG. 11 is a diagram showing an example of the snapshot configuration information 1006 that is stored in the storage subsystem 100 according to the first embodiment of this invention.

The snapshot configuration information 1006 contains communication interface identification information 10060, logical storage unit identification information 10061, a time 10062, snapshot identification information 10063, and reference permission/prohibition status information 10064.

The communication interface identification information 10060 is the identifier of a communication interface coupled to a logical storage unit of which a snapshot is obtained. The logical storage unit identification information 10061 is the identifier of a logical storage unit of which a snapshot is obtained. The time 10062 is a time when a snapshot is obtained. The snapshot identification information 10063 is an identifier by which a snapshot is identified. The reference permission/prohibition status information 10064 is information indicating whether to permit the snapshot identified by the snapshot identification information 10063 to be referred to.

A snapshot obtained at the time 10062 of a logical storage unit identified by the logical storage unit identification information 10061 is identified by the snapshot identification information 10063. In the first embodiment of this invention, when a logical storage unit can be referred to, a letter string “permitted” is recorded as the reference permission/prohibition status information 10064 whereas “prohibited” is recorded when the logical storage unit cannot be referred to. Whether to permit reference to a logical storage area can be set depending on generation by varying the value of the reference permission/prohibition status information 10064 such that, for example, reference to a snapshot of the logical storage unit at a specific time point alone is prohibited.

FIG. 12 is a diagram showing an example of the external connection configuration mapping information 1007 which is stored in the storage subsystem 100 according to the first embodiment of this invention.

The external connection configuration mapping information 1007 holds the correspondence between a logical storage area and an external logical storage unit. The external connection configuration mapping information 1007 contains logical storage area identification information 10071 and externally coupled resource information 10072.

The logical storage area identification information 10071 is an identifier by which a logical storage area is identified. The externally coupled resource information 10072 contains subsystem identification information 10073 and logical storage unit identification information 10074. The subsystem identification information 10073 is an identifier for identifying each storage subsystem 100. The logical storage unit identification information 10074 is an identifier by which a logical storage unit is identified. A logical storage unit that is identified by the logical storage unit identification information 10074 is stored in the storage subsystem 100 that is identified by the subsystem identification information 10073.

FIG. 13 is a diagram showing an example of the host computer storage volume configuration information 3001 which is stored in the host computer 300 according to the first embodiment of this invention.

The host computer storage volume configuration information 3001 holds information of a storage device mounted to the host computer 300. The host computer storage volume configuration information 3001 contains storage volume identification information 30011, storage device identification information 30012, communication interface identification information 30013, and storage unit identification information 30014.

The storage volume identification information 30011 is an identifier by which a storage volume mounted to the host computer 300 is identified. The storage device identification information 30012 is the identifier of a storage device that provides a storage volume mounted to the host computer 300. The communication interface identification information 30013 is the identifier of a communication interface coupled to a storage device that is identified by the storage device identification information 30012. The storage unit identification information 30014 is the identifier of a storage unit corresponding to a storage device that is identified by the storage device identification information 30012.

An input/output request for data in a storage volume that is identified by the storage volume identification information 30011 is executed in a logical storage unit set to the data input/output communication interface 140 of the storage subsystem 100 over the data input/output network.

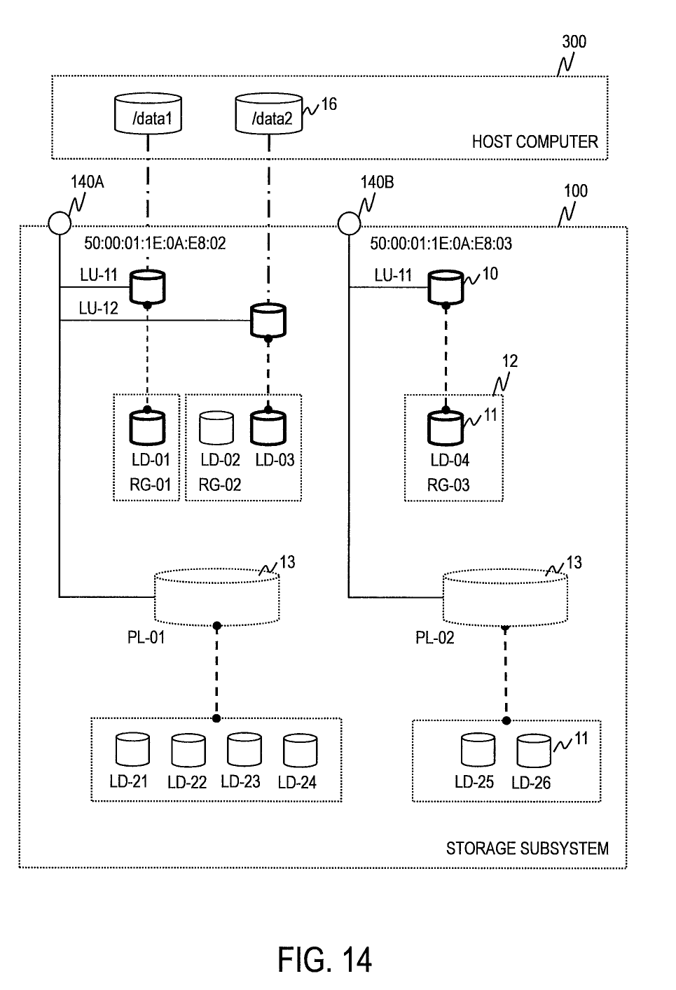

FIG. 14 is a diagram showing an example of the configuration of a storage system according to the first embodiment of this invention. The storage system of FIG. 14 is configured based on the configuration information shown in FIGS. 6 to 13.

The storage subsystem 100 stores RAID groups 12 (RG-01, RG-02, and RG-03) as shown in FIG. 6. Logical storage areas 11 are defined to belong to the RAID groups 12. For example, a logical storage area “LD-01” is defined within the RAID group “RG-01”.

The logical storage areas 11 are associated with logical storage units 10. In the example of FIG. 7, a storage unit “LU-11” corresponding to a data input/output communication interface “50:00:01:1E:0A:E8:02” corresponds to the logical storage area “LD-01”.

The logical storage units 10 are also associated with host computer storage volumes 16 on the host computer 300 as shown in FIG. 13. In the example of FIG. 13, the storage unit “LU-11” corresponding to the data input/output communication interface “50:00:01:1E:0A:E8:02” corresponds to a storage volume “/data1” of the host computer 300.

Backup virtual storage area pools 13 are each constituted of a group of logical storage areas 11 as shown in FIG. 9. In the example of FIG. 9, a virtual storage area pool “PL-01” is constituted of logical storage areas “LD-21”, “LD-22”, “LD-23”, and “LD-24”.

The backup virtual storage area pools 13 are associated with the logical storage units 10. In the example of FIG. 8, the virtual storage area pool “PL-01” is associated with logical storage units “LU-11” and “LU-12”.

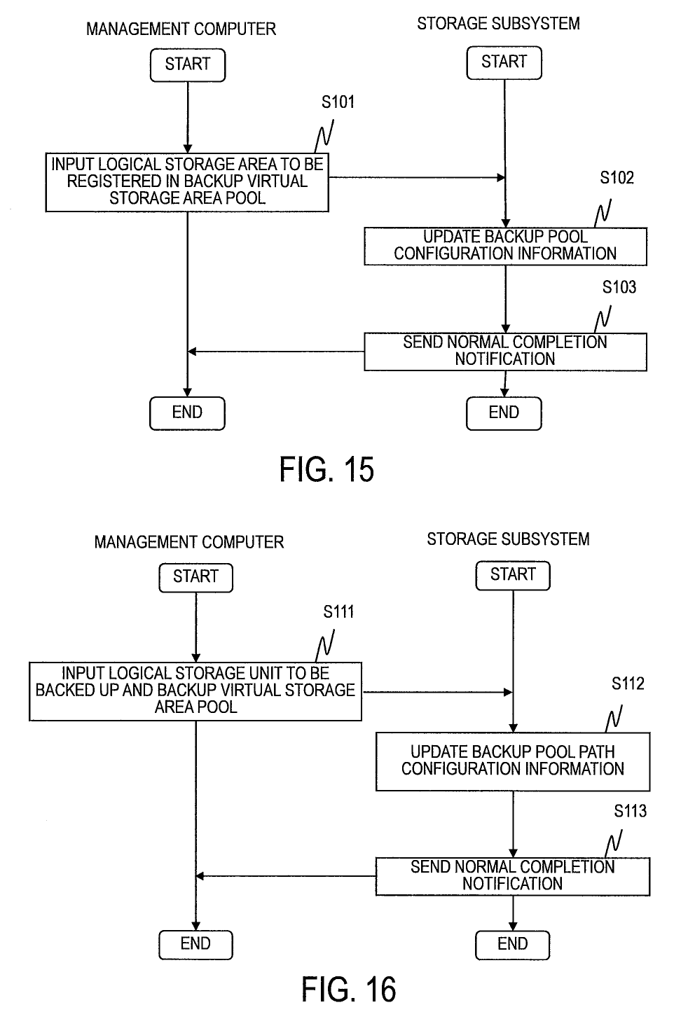

FIG. 15 is a flow chart showing the steps of allocating a logical storage area to a backup virtual storage area pool in backup virtual storage area pool creating processing according to the first embodiment of this invention.

This processing is executed by running the backup pool management program 1009 in the storage subsystem 100.

The processing unit 580 of the management computer 500 receives from an administrator an input that contains a number assigned to a backup virtual storage area pool and a logical storage area to be registered to this backup virtual storage area pool (Step S101). The input information is sent to the storage subsystem 100.

The storage controller 190 of the storage subsystem 100 receives the information input in Step S101 from the management computer 500, and updates the backup pool configuration information 1004 such that the logical storage area specified in the input information is added to the similarly specified backup virtual storage area pool (Step S102). When the above step is completed, the storage controller 190 of the storage subsystem 100 sends a normal completion notification to the management computer 500 (Step S103).

FIG. 16 is a flow chart showing the steps of allocating a logical storage unit to be backed up to a backup virtual storage area pool in the backup virtual storage area pool creating processing according to the first embodiment of this invention.

This processing is executed by running the backup pool management program 1009 in the storage subsystem 100. This processing is executed after the processing shown in the flow chart of FIG. 15 is completed.

The processing unit 580 of the management computer 500 receives from the administrator an input that contains a logical storage unit and a number assigned to a backup virtual storage area pool in which backup data of this logical storage unit is stored (Step S111). In the case where the processing of FIG. 15 and this processing are executed in succession to specify a logical storage unit, a logical storage unit alone may be specified in Step S111. The input information is sent to the storage subsystem 100.

The storage controller 190 of the storage subsystem 100 receives the information input in step S111 from the management computer 500, and updates the backup pool path configuration information 1003 such that a place where backup data of the input logical storage unit is recorded is to be the input backup virtual storage area pool (Step S112). When the above step is completed, the storage controller 190 of the storage subsystem 100 sends a normal completion notification to the management computer 500 (Step S113).

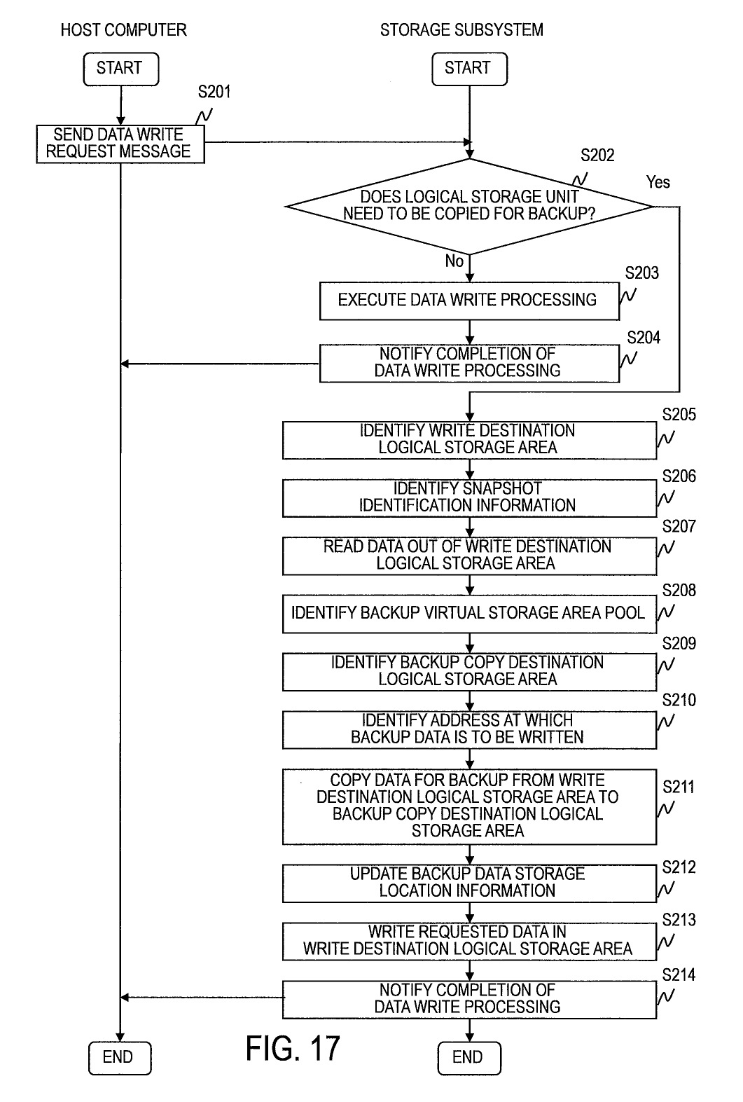

FIG. 17 is a flow chart showing the steps of writing data in a logical storage area in the storage subsystem 100 according to the first embodiment of this invention.

In writing data in the storage subsystem 100, the processing unit 380 of the host computer 300 executes the data write request program 3002 to send a data write request message (Step S201). Specifically, the processing unit 380 first refers to the host computer storage volume configuration information 3001 and determines from the storage volume identification information 30011 a host computer storage volume in which data is to be written. The processing unit 380 then creates a data write request message designating the data input/output communication interface 140 and a logical storage unit in a record corresponding to the determined host computer storage volume as a place where the data is to be written, and sends the message to the storage subsystem 100.

Receiving the data write request message from the host computer 300, the storage controller 190 of the storage subsystem 100 executes the storage area configuration management program 1008 to judge whether or not the logical storage unit in which the data is requested to be written should be copied for backup (Step S202). Specifically, the storage controller 190 searches the backup pool path configuration information 1003 to judge whether or not a backup virtual storage area pool is recorded therein corresponding to the logical storage unit that is designated in the data write request message as a place in which the data is to be written.

When the logical storage unit in which the data is requested to be written is not one that needs to be copied for backup (the answer to Step S202 is “No”), the storage controller 190 of the storage subsystem 100 executes data write processing (Step S203). After the data write is completed, the storage controller 190 sends a data write processing completion notification to the host computer 300 (Step S204).

When the logical storage unit in which the data is requested to be written is one that needs to be copied for backup (the answer to Step S202 is “Yes”), the storage controller 190 of the storage subsystem 100 executes the storage area configuration management program 1008 and refers to the logical storage unit configuration information 1002 to identify a logical storage area in which the data is to be written (write destination logical storage area) (Step S205).

The storage controller 190 of the storage subsystem 100 executes the snapshot management program 1011 and refers to the snapshot configuration information 1006 to identify the snapshot identification information 10063 of the logical storage unit recorded as the logical storage unit identification information 10061 (Step S206).

The storage controller 190 of the storage subsystem 100 executes the backup data recording program 1014 to read data that has been recorded at a write location within the write destination logical storage area (Step S207).

The storage controller 190 of the storage subsystem 100 executes the backup pool management program 1009 and refers to the backup pool path configuration information 1003 to identify from the backup virtual storage resource pool identification information 10031 a backup virtual storage area pool to which the read data is to be copied for backup (Step S208).

The storage controller 190 of the storage subsystem 100 searches the backup data storage location information 1005 for any entry whose logical storage unit information 10051 matches the address of the logical storage unit that is designated in Step S201 as a place in which the data is requested to be written. From among entries that meet the condition, an entry whose snapshot identification information 10053 matches the snapshot identified in Step S206 is chosen. When there is an entry that meets the condition, a storage area corresponding to the logical storage area information 10052 of this entry is set as the logical storage area to which the read data is to be copied for backup (backup copy destination logical storage area) (Step S209). When there is no entry that meets the condition, on the other hand, one of the logical storage areas that constitute the backup pool to which the designated logical storage unit is to be backed up is chosen and any part of this logical storage area which is partitioned by address is set as a new backup copy destination logical storage area.

The storage controller 190 of the storage subsystem 100 executes the backup data management program 1010 and refers to the backup data storage location information 1005 to set the initiation block address 10052B and termination block address 10052C of the backup copy destination logical storage area as the address of a space in which this backup data is to be stored (Step S210).

The storage controller 190 of the storage subsystem 100 executes the backup data recording program 1014 to write the data read in Step S207 in an address space of the backup copy destination logical storage area identified in Step S209 (Step S211). The storage controller 190 then makes an update so that the backup data storage location information 1005 reflects the fact that backup data of the write destination logical storage area is now stored in a part of the backup copy destination logical storage area at the relevant address (Step S212).

The storage controller 190 of the storage subsystem 100 writes the requested data in the write destination logical storage area as requested in Step S201 (Step S213). After the data write processing is completed, a message to the effect that the data write processing has been finished normally is sent to the host computer 300 (Step S214), whereby the data write processing is ended.

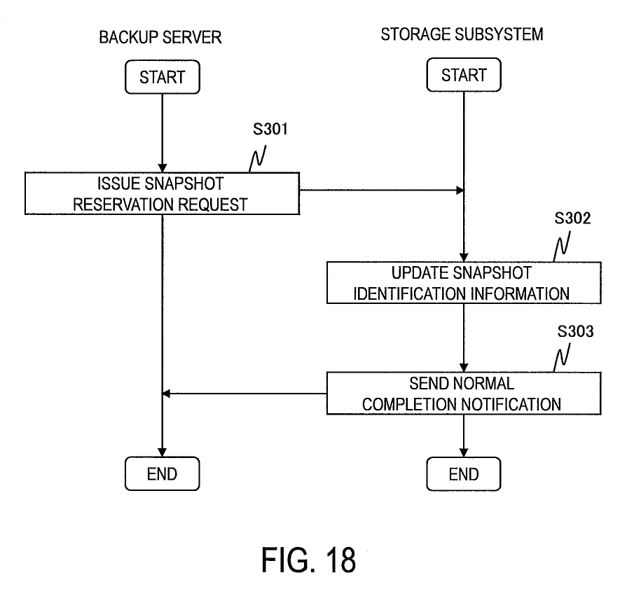

FIG. 18 is a flow chart showing the steps of processing of updating the snapshot configuration information 1006 that is stored in the storage subsystem 100 according to the first embodiment of this invention.

The processing unit 480 of the backup server 400 periodically executes the snapshot reservation request program 4001 to send a snapshot reservation request message to the storage subsystem 100 (Step S301). The snapshot reservation request contains the identification information of a logical storage unit of which a snapshot is requested to be obtained.

The storage controller 190 of the storage subsystem 100 receives the snapshot reservation request message and executes the snapshot management program 1011 to register a new snapshot number as the snapshot identification information 10053 of the backup data storage location information 1005 and the current time as the time 10054 (Step S302).

After finishing updating the backup data storage location information 1005, the storage controller 190 of the storage subsystem 100 sends a normal completion notification of the update processing to the backup server 400 (Step S303).

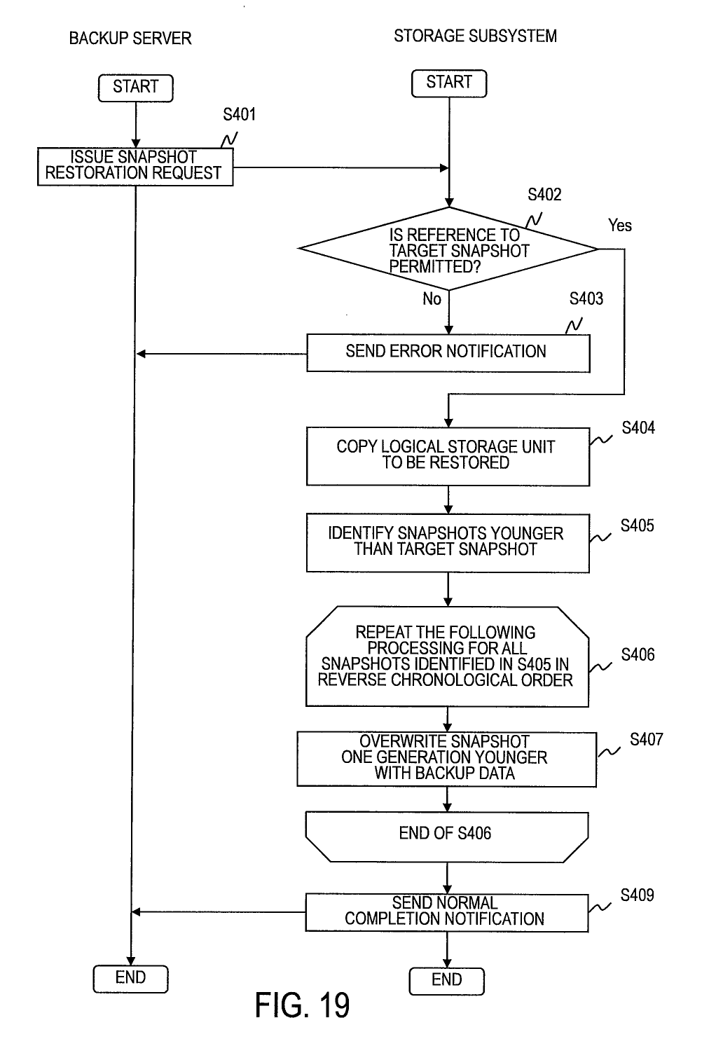

FIG. 19 is a flow chart showing the steps of snapshot restoration processing in the storage subsystem 100 according to the first embodiment of this invention.

The processing unit 480 of the backup server 400 executes the snapshot restoration request program 4002 to send a snapshot restoration request message to the storage subsystem 100 (Step S401). The snapshot restoration request message contains information of a logical storage unit to be restored and specifies to which time point the logical storage unit is to be restored.

The storage controller 190 of the storage subsystem 100 receives the snapshot restoration request message and executes the snapshot management program 1011 to refer to the snapshot configuration information 1006. From the reference permission/prohibition status information 10064 of a snapshot obtained at the specified time point of the logical storage unit to be restored, the storage controller 190 judges whether the snapshot of the logical storage unit to be restored can be referred to or not (Step S402).

When the reference permission/prohibition status information 10064 holds a value “prohibited”, in other words, the snapshot cannot be referred to (the answer to Step S402 is “No”), the storage controller 190 of the storage subsystem 100 sends an error notification to the backup server 400 (Step S403).

When the reference permission/prohibition status information 10064 holds a value “permitted”, in other words, the snapshot can be referred to (the answer to Step S402 is “Yes”), the storage controller 190 of the storage subsystem 100 executes Step S404 and subsequent steps.

The storage controller 190 of the storage subsystem 100 executes the snapshot restoration program 1015 and makes a copy of the logical storage unit to be restored at the time of reception of the restoration request (Step S404).

The storage controller 190 of the storage subsystem 100 executes the snapshot management program 1011 and refers to the backup data storage location information 1005 to identify every snapshot whose logical storage unit identification information 10051A matches the logical storage unit to be restored and whose time 10054 is later than the specified time point (Step S405).

For every snapshot identified in Step S405, the storage controller 190 of the storage subsystem 100 uses the snapshot restoration program 1015 to execute the following processing in reverse chronological order, starting from the latest snapshot (Step S406).

The storage controller 190 of the storage subsystem 100 overwrites a snapshot one generation younger than the one being processed with data stored in a logical storage area whose snapshot corresponds to the one to be processed and that is identified by the logical storage area identification information 10052A of the backup data storage location information 1005 (Step S407).

After the snapshot restoration is completed, the storage controller 190 of the storage subsystem 100 uses the snapshot management program 1011 to send a normal completion notification to the backup server 400 (Step S409).

In the first embodiment of this invention, when data is written from the host computer 300 in a logical storage unit of the storage subsystem 100, differential copy is executed to copy differential data from a logical storage area that constitutes this logical storage unit to a backup virtual storage area pool. Data erasure from a logical storage area involves writing dummy data a plurality of times throughout the entire area. Therefore, when simple data erasure processing is employed, a large amount of differential copy is created, thus increasing the load on the system. Stopping differential copy, on the other hand, allows backup data to remain in the system, which is a security risk. The first embodiment of this invention solves this through unique data erasure processing which reduces the security risk while suppressing the load on the system from increasing.

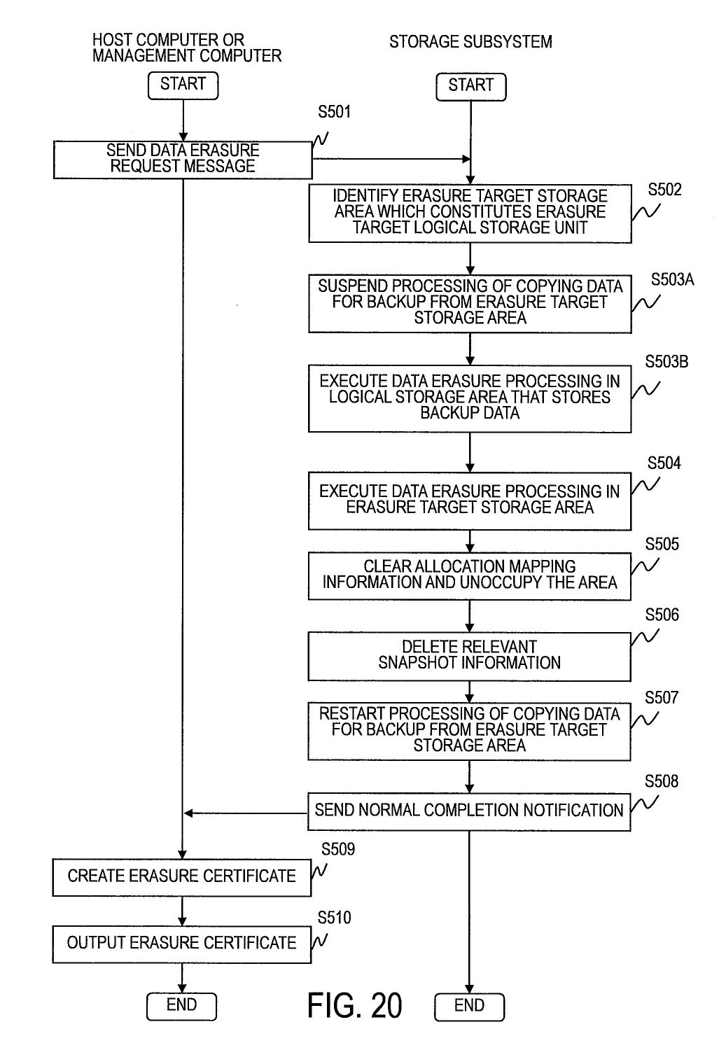

FIG. 20 is a flow chart showing the steps of processing of erasing data from a logical storage area in the storage subsystem 100 according to the first embodiment of this invention.

The processing unit 380 of the host computer 300 executes the data erasure request program 3003 to determine a host computer storage volume from which data is to be erased based on the storage volume identification information 30011 of the host computer storage volume configuration information 3001. A data erasure request message specifying a logical storage unit is then sent to the data input/output communication interface 140 corresponding to the volume (Step S501). The data erasure request message may be sent from the management computer 500 to the storage subsystem 100.

The storage controller 190 of the storage subsystem 100 receives the data erasure request message and executes the storage area configuration management program 1008. The storage controller 190 searches the logical storage unit configuration information 1002 constituting the storage unit whose data is requested to be erased by the data erasure request message (erasure target logical storage unit), to thereby find a corresponding logical storage area from which data is to be erased (erasure target logical storage area) (Step S502). In the case where the logical storage unit whose data is requested to be erased is stored in the externally coupled storage subsystem 100, the external connection configuration mapping information 1007 is searched for an entry of the erasure target logical storage unit to retrieve the corresponding erasure target logical storage area.

The storage controller 190 of the storage subsystem 100 executes the backup data recording program 1014 to suspend backup data copy processing in the erasure target logical storage area (Step S503A).

The storage controller 190 of the storage subsystem 100 identifies a snapshot corresponding to the erasure target logical storage unit based on the backup data storage location information 1005. The storage controller 190 uses the data erasure program 1013 to execute data erasure processing for a logical storage area that stores this snapshot (Step S503B). The logical storage area storing the snapshot is specified on a block basis by the initiation block address 10052B and the termination block address 1005C in the backup data storage location information 1005.

The storage controller 190 of the storage subsystem 100 also executes data erasure processing for the erasure target logical storage area with the use of the data erasure program 1013 (Step S504).

The storage controller 190 of the storage subsystem 100 executes the backup data management program 1010 to delete all record entries corresponding to the erasure target logical storage unit from the backup data storage location information 1005 (Step S505).

The storage controller 190 of the storage subsystem 100 executes the snapshot management program 1011 to delete entries corresponding to the erasure target logical storage unit from the snapshot configuration information 1006 (Step S506).

The storage controller 190 of the storage subsystem 100 then uses the backup data recording program 1014 to restart the processing of copying data for backup from the erasure target logical storage area (Step S507).

The storage controller 190 of the storage subsystem 100 uses the storage area configuration management program 1008 to send a normal completion notification message to the backup server 400 (Step S508). The normal completion notification message contains information necessary to create an erasure certificate in Step S509, such as the identification information of the erasure target logical storage area, the erasure completion time, the data erasure algorithm employed, and the number of times of overwriting for erasure.

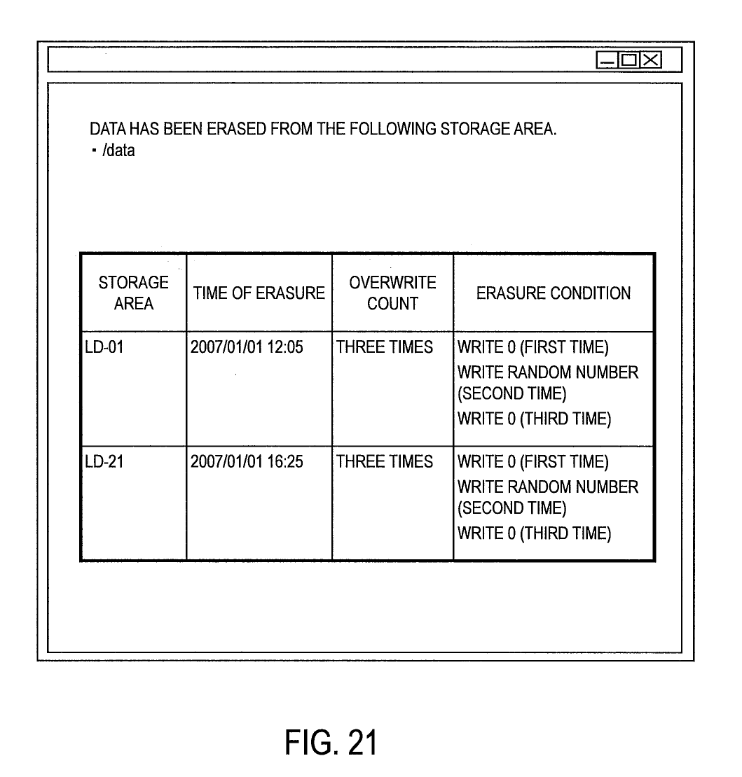

Receiving the normal completion notification message, the processing unit 580 of the management computer 500 executes the erasure certificate creating program 5002 to create an erasure certificate (Step S509). The processing unit 580 then executes the erasure certificate outputting program 5003 to output the created erasure certificate via the output interface 575 (Step S510). An example of the erasure certificate will be described below with reference to FIG. 21.

FIG. 21 is a diagram showing an example of information output on an erasure certificate according to the first embodiment of this invention.

A list of storage volumes in which data erasure processing has been executed is output to an erasure certificate along with erasure conditions. In the case where data is erased from a backup destination storage area as well, information such as the identification information of the relevant snapshot and the time when the replication has been created may be included in the erasure certificate.

Referring to a configuration example shown in FIG. 14, a specific description on data erasure processing will now be given. The description takes as an example of a case of erasing the storage volume “/data1” from the host computer 300.

The processing unit 380 of the host computer 300 executes the data erasure request program 3003 to send a data erasure request message to the storage subsystem 100 that provides the storage volume to be erased (Step S501 of FIG. 17). Specifically, the processing unit 380 identifies the logical storage unit 10 corresponding to the storage volume “/data1” to be erased and a communication interface that is coupled to this logical storage unit 10. Referring to the host computer storage volume configuration information 3001 shown in FIG. 13, the storage volume “/data1” corresponds to the communication interface “50:00:01:1E:0A:E8:02” and the storage unit “LU-11”. The processing unit 380 of the host computer 300 sends the data erasure request message to the communication interface “50:00:01:1E:0A:E8:02”.

Receiving the data erasure request message, the storage controller 190 of the storage subsystem 100 searches the storage area identification information 10023 to identify “LD-01” as the logical storage area 11 that constitutes the storage unit “LU-11” whose data is to be erased (Step S502 of FIG. 17).

The storage controller 190 of the storage subsystem 100 executes the backup data recording program 1014 to suspend the processing of copying data for backup from the logical storage area “LD-01” (Step S503A of FIG. 17).

The storage controller 190 of the storage subsystem 100 executes the data erasure program 1013 to identify which logical storage area stores a backup of the logical storage area “LD-01”. Referring to the backup data storage location information 1005 and the snapshot configuration information 1006, “LD-21”, “LD-22”, and “LD-23” are identified as the logical storage areas storing backup data of “LD-01”. The storage controller 190 then erases stored data from the identified logical storage areas (Step S503B of FIG. 17). “LD-21” (“SS-01”, “SS-02”) and “LD-22” (“SS-03”), which are shared by “LU-12” (“SS-05”, “SS-06”), are excluded from objects to be deleted. The storage controller 190 then executes data erasure processing in the logical storage area “LD-01” (Step S504 of FIG. 17).

The storage controller 190 of the storage subsystem 100 executes the backup data management program 1010 to delete every record entry in the backup data storage location information 1005 whose logical storage unit identification information 10051A is “LU-11” (Step S505 of FIG. 17).

The storage controller 190 of the storage subsystem 100 then executes the backup data recording program 1014 to restart the processing of copying data for backup from the logical storage area “LD-01” (Step S507 of FIG. 17).

The storage controller 190 of the storage subsystem 100 executes the storage area configuration management program 1008 to send an erasure completion notification to the management computer 500 (Step S508 of FIG. 17).

The processing unit 580 of the management computer 500 creates an erasure certificate (Step S509 of FIG. 17) and outputs the certificate through the output interface 575 (Step S510 of FIG. 17).

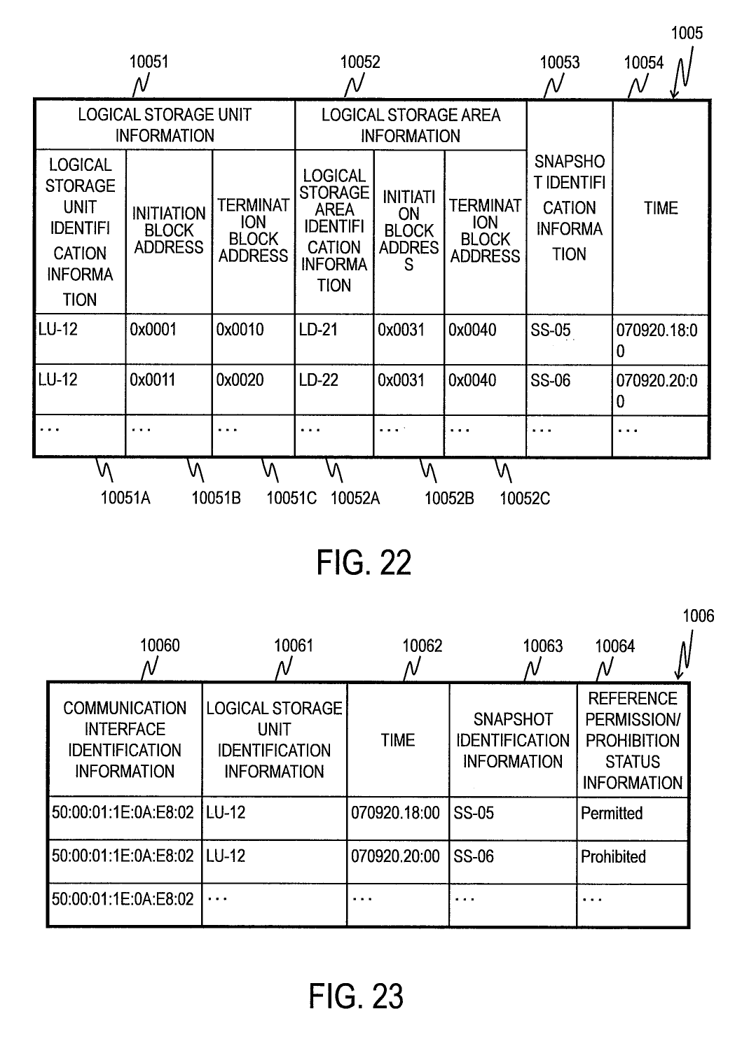

The backup data storage location information 1005 and the snapshot configuration information 1006 after updated through the above processing are shown in FIGS. 22 and 23, respectively.

FIG. 22 is a diagram showing an example of the backup data storage location information 1005 after the data erasure processing according to the first embodiment of this invention. Compared to FIG. 10, entries whose logical storage unit identification information 10051A is “LU-11” are deleted in FIG. 22.

FIG. 23 is a diagram showing an example of the snapshot configuration information 1006 after the data erasure processing according to the first embodiment of this invention. As described above, entries whose logical storage unit identification information 10051A is “LU-11” are deleted in FIG. 23.

In the case of deleting a snapshot of a selected generation, only the deletion of relevant entries corresponding to the backup data storage location information 1005 and the snapshot configuration information 1006 is carried out without executing data erasure processing in a logical storage area that stores a snapshot to be deleted.

According to the first embodiment of this invention, creating a large amount of differential copy data in a system that executes differential copy can be avoided by applying shredding technology.

The first embodiment of this invention also makes it possible to completely erase backup data of data stored in a logical storage unit. A storage area storing the backup data can be erased on a block basis.

### Second Embodiment

A second embodiment of this invention describes a case of executing backup while eliminating duplicate backup data. In the second embodiment, data copy is executed only when a backup virtual storage area pool does not already have the same data as the one stored in a block to be backed up by running the deduplication recording program 1016 that is stored in the storage subsystem 100.

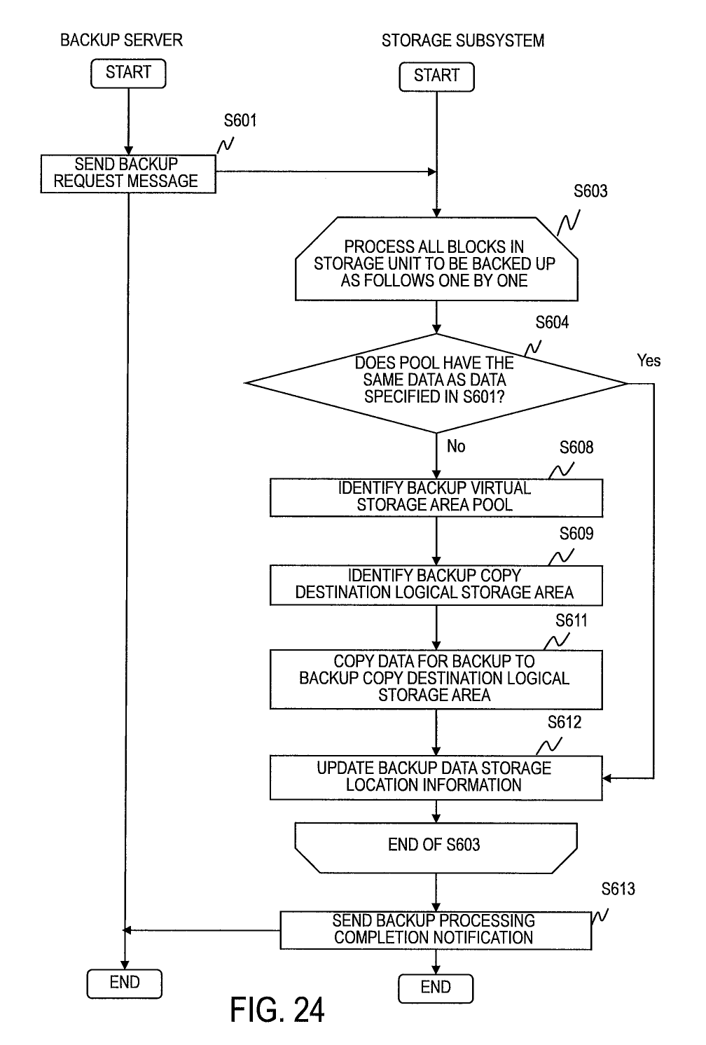

FIG. 24 is a flow chart showing the steps of backup processing in the storage subsystem 100 according to the second embodiment of this invention.

The processing unit 480 of the backup server 400 executes the backup request program 4003 to send a backup request message to the storage subsystem 100 (Step S601). The backup request message contains information for identifying a logical storage unit to be backed up.

The storage controller 190 of the storage subsystem 100 executes the deduplication recording program 1016 to perform the following processing on every block that constitutes the logical storage unit to be backed up (Step S603).

The storage controller 190 of the storage subsystem 100 refers to the backup data storage location information 1005 and checks every piece of backup data stored in backup virtual storage area pools to judge whether or not any of the backup data is the same as data to be backed up (Step S604).

When the backup virtual storage area pools do not have the same data as data to be backed up (the answer to Step S604 is “No”), the storage controller 190 of the storage subsystem 100 executes processing of writing this data in a backup virtual storage area.

The storage controller 190 of the storage subsystem 100 executes the backup pool management program 1009 and refers to the backup pool path configuration information 1003 to identify a backup virtual storage area pool in which backup data of the logical storage unit to be backed up should be recorded (Step S608).

The storage controller 190 of the storage subsystem 100 also refers to the backup pool configuration information 1004 to identify, from the logical storage area identification information 10042, a logical storage area to which the data is to be copied for backup (backup copy destination logical storage area) (Step S609).

The storage controller 190 of the storage subsystem 100 executes the backup data recording program 1014 to copy the data to be backed up to an address space corresponding to the backup copy destination logical storage area (Step S611).

The storage controller 190 of the storage subsystem 100 executes the backup data management program 1010 to add a record to the backup data storage location information 1005. In the added record entry, the backup virtual storage area pool to which data of the block to be backed up has been copied in Step S611 is recorded as the location of the data (Step S612).

On the other hand, when the same data as data to be backed up is found in a physical address space that is identified by the initiation block address 10052B and the termination block address 10052C (the answer to Step S604 is “Yes”), the storage controller 190 of the storage subsystem 100 does not write backup data and updates the backup data storage location information 1005 such that this data block is referred to (Step S612). As a result, the areas of at least two logical storage units share a single area defined in the logical storage area information 10052.

For example, in FIG. 10, an area expressed as a virtual address space from “0x001” to “0x0020” of “LU-11” recorded as the logical storage unit identification information 10051A and an area expressed as a virtual address space from “0x0001” to “0x0010” of “LU-12” both refer, as backup data destination, to an area expressed as a physical address space from “0x0031” to “0x0040” of “LD-21” recorded as the logical storage area identification information 10052A.

After the backup processing is completed, the storage controller 190 of the storage subsystem 100 sends a message to the effect that the backup processing has been completed normally to the host computer 300 (Step S613), whereby the data write processing according to the second embodiment of this invention is ended.

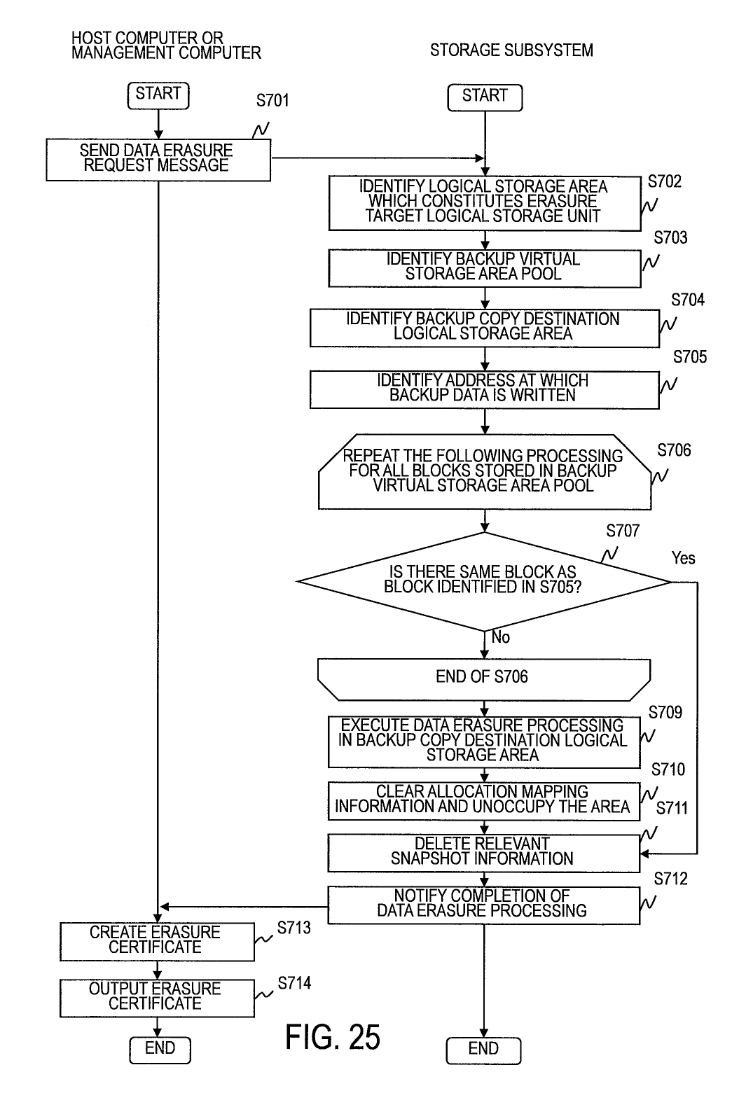

FIG. 25 is a flow chart showing the steps of processing of erasing data from a logical storage area in the storage subsystem 100 according to the second embodiment of this invention.

To erase data from a storage area that is mounted to the host computer 300, the processing unit 380 of the host computer 300 executes the data erasure request program 3003. Specifically, the processing unit 380 first determines a host computer storage volume from which data is to be erased based on the storage volume identification information 30011 of the host computer storage volume configuration information 3001. The processing unit 380 then sends a data erasure request message designating a logical storage unit corresponding to the volume as a place from which data is to be erased to the data input/output communication interface 140 corresponding to the volume (Step S701).

The storage controller 190 of the storage subsystem 100 receives the data erasure request message and executes the storage area configuration management program 1008. The storage controller 190 searches the logical storage unit configuration information 1002 constituting the storage unit whose data is requested to be erased, which is included in the received data erasure request message, to thereby find a corresponding logical storage area (Step S702).

The storage controller 190 of the storage subsystem 100 executes the backup pool management program 1009 and refers to the backup pool path configuration information 1003 to identify a backup virtual storage area pool to which the data is copied for backup from the backup virtual storage resource pool identification information 10031 (Step S703).

The storage controller 190 of the storage subsystem 100 also refers to the backup pool configuration information 1004 to identify a logical storage area to which the data is copied for backup (backup copy destination logical storage area) from the logical storage area identification information 10042 (Step S704).

The storage controller 190 of the storage subsystem 100 executes the backup data management program 1010 and refers to the backup data storage location information 1005 to identify the address of a backup copy destination address space based on the initiation block address 10052B and termination block address 10052C of the backup copy destination logical storage area (Step S705).

The storage controller 190 of the storage subsystem 100 executes the deduplication recording program 1016 to perform the following processing on every physical address space identified by the initiation block address 10052B and the termination block address 10052C which are recorded in the logical storage area information 10052 of the backup data storage location information 1005 (Step S706).

The storage controller 190 of the storage subsystem 100 refers to the logical storage area information 10052 of the backup data storage location information 1005 to judge whether or not the block address identified in Step S705 is found in at least two records (Step S707).

When the block address identified in Step S705 is found in only one record (the answer to Step S707 is “No”), the storage controller 190 of the storage subsystem 100 runs the data erasure program 1013 to execute data erasure processing in the logical storage area from which data is to be erased (erasure target logical storage area) (Step S709).

The storage controller 190 of the storage subsystem 100 uses the backup data management program 1010 to delete every record for the erasure target logical storage unit from the backup data storage location information 1005 (Step S710). In deleting those records, data at the relevant address in a logical storage area that is associated with the erasure target logical storage unit may be deleted.

When the block address identified in Step S705 is found in at least two records (the answer to Step S707 is “Yes”), the storage controller 190 of the storage subsystem 100 executes the snapshot management program 1011 to delete data corresponding to the erasure target logical storage unit from the snapshot configuration information 1006 (Step S711).

The storage controller 190 of the storage subsystem 100 executes the storage area configuration management program 1008 to send a normal completion notification message to the backup server 400 (Step S712). The normal completion notification message contains information necessary to create an erasure certificate in Step S713, such as the identification information of the erasure target logical storage area, the erasure completion time, the data erasure algorithm employed, and the number of times of overwriting for erasure.

Receiving the normal completion notification message, the processing unit 580 of the management computer 500 executes the erasure certificate creating program 5002 to create an erasure certificate (Step S713). The processing unit 580 then executes the erasure certificate outputting program 5003 to output the created erasure certificate via the output interface 575 (Step S714).

According to the second embodiment of this invention, complete erasure of data including backup data is accomplished in a deduplication type storage system as well while reducing the load on the system.

### Third Embodiment

A third embodiment of this invention describes a case of employing a backup method in which data restoration time points are set continuously (CDP). In this backup method, when data is written in the logical storage area 11 recorded as the logical storage area identification information 10052A in one record of the backup data storage location information 1005 of FIG. 10, the time 10054 in the corresponding record is not updated and a new record is added instead to update the time 10054.

In the third embodiment of this invention, when the host computer 300 issues a request to write data in one of the logical storage units 10 of the storage subsystem 100, differential copy is executed to copy differential data from the logical storage area 11 that constitutes the corresponding logical storage unit 10 to one of the backup virtual storage area pools 13 as in the first embodiment. Data erasure from a logical storage area involves writing dummy data a plurality of times throughout the entire area. Therefore, when simple data erasure processing is employed, a large amount of differential data to be copied is created, thus increasing the load on the system.

The third embodiment of this invention solves the problem by data write processing the steps of which are shown in FIG. 17. From Steps S201 to S209, the data write processing of this embodiment is the same as the data write processing of the first embodiment.

After Step S209 is completed, the storage controller 190 of the storage subsystem 100 executes the backup data management program 1010 and refers to the backup data storage location information 1005 to add an entry for the address of a backup copy destination address space based on the initiation block address 10052B and termination block address 10052C of the backup copy destination logical storage area. In the added record entry, the snapshot identification information 10053 holds an updated number (Step S210).

The storage controller 190 of the storage subsystem 100 executes the backup data recording program 1014 to copy the data read in Step S207 to the address space in the backup copy destination logical storage area that has been identified in Step S210 (Step S211).

The storage controller 190 of the storage subsystem 100 executes the backup data management program 1010 to update the time 10054 in the entry newly added to the backup data storage location information 1005 (Step S212). In the first embodiment, when data to be backed up is already recorded in a backup virtual storage area, the backup data is overwritten in Step S210 instead of adding a new entry. In the third embodiment, on the other hand, a backup is saved for every data write session by creating a new entry for recording backup data each time a write request is issued.

Steps S213 and S214 in the third embodiment are the same processing steps as those in FIG. 17. Data erasure processing of the third embodiment is the same as that of the first embodiment shown in FIG. 20.

According to the third embodiment of this invention, complete erasure of data including backup data is accomplished also in a storage system that employs CDP, which makes restoration to any time point possible, while reducing the load on the system.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a storage subsystem which stores data read and written by a host computer; and
a management computer which has access to the storage subsystem,
wherein the storage subsystem comprises a first interface coupled to the host computer, a first processor coupled to the first interface, and a first memory coupled to the first processor, provides a first storage area which stores the data, and includes a second storage area which stores a replication of the data stored in the first storage area,
wherein the management computer comprises a second interface coupled to the storage subsystem, a second processor coupled to the second interface, and a second memory coupled to the second processor,
wherein, when the data stored in the first storage area is to be updated, the storage subsystem replicates unupdated data to the second storage area,
wherein, upon reception of a request to erase the data stored in the first storage area, the management computer sends the request to erase the data stored in the first storage area to the storage subsystem, and
wherein the storage subsystem suspends replication of the unupdated data to the second storage area upon reception of the request to erase the data stored in the first storage area, and erases the data stored in the first storage area based on the request to erase the data.

2. The computer system according to claim 1, wherein, after suspending the replication of the data stored in the first storage area to the second storage area, the storage subsystem erases data stored in the second storage area corresponding to the first storage area.

3. The computer system according to claim 2, wherein the storage subsystem erases the data stored in the first storage area and the data stored in the second storage area by overwriting the first storage area and the second storage area with given dummy data a plurality of times.

4. The computer system according to claim 3, wherein, in the case of which the erasing the data stored in the first storage area and the data stored in the second storage area is completed, the management computer outputs a notification that the data stored in the first storage area and the data stored in the second storage area have been erased.

5. The computer system according to claim 2, wherein, when the second storage area corresponding to the first storage area further corresponds to first storage areas other than the first storage area from which the data is requested to be erased, the storage subsystem prevents erasing the data stored in the second storage area.

6. The computer system according to claim 1, wherein, after erasing the data stored in the first storage area, the storage subsystem restarts the replication of the unupdated data to the second storage area.

7. The computer system according to claim 1,
wherein the computer system manages information on correspondence between the data stored in the first storage area and the data replicated to the second storage area on a generation basis, and
wherein, when the data of a selected generation replicated to the second storage area is to be erased, the storage subsystem deletes an entry for data of the generation to be erased from the information on correspondence.

8. A storage subsystem which stores data read and written by a host computer, comprising:
an interface coupled to the host computer;
a processor coupled to the interface; and
a first memory coupled to the processor,
the storage subsystem providing a first storage area which stores the data, and including a second storage area which stores a replication of the data stored in the first storage area,
wherein the processor is configured to:
replicate, when the data stored in the first storage area is to be updated, unupdated data to the second storage area;
suspend, upon reception of a request to erase the data stored in the first storage area, replication of the unupdated data to the second storage area; and
erase the data stored in the first storage area based on the request to erase the data.

9. The storage subsystem according to claim 8, wherein, the processor is further configured to erase, after suspending the replication of the data stored in the first storage area to the second storage area, data stored in the second storage area corresponding to the first storage area.

10. The storage subsystem according to claim 9, wherein, the processor is further configured to erase the data stored in the first storage area and the data stored in the second storage area by overwriting the first storage area and the second storage area with given dummy data a plurality of times.

11. The storage subsystem according to claim 9, wherein, when the second storage area corresponding to the first storage area further corresponds to first storage areas other than the first storage area from which the data is requested to be erased, the processor is further configured to prevent erasing the data stored in the second storage area.

12. The storage subsystem according to claim 8, wherein, after erasing the data stored in the first storage area, the processor is further configured to restart the replication of the unupdated data to the second storage area.

13. The storage subsystem according to claim 8, wherein the processor is configured to:
manage information on correspondence between the data stored in the first storage area and the data replicated to the second storage area on a generation basis; and
delete, when the data of a selected generation replicated to the second storage area is to be erased, an entry for data of the generation to be erased from the information on correspondence.

14. A data management method used in a computer system having a storage subsystem which stores data read and written by a host computer and a management computer which has access to the storage subsystem,
the storage subsystem having a first interface coupled to the host computer, a first processor coupled to the first interface, and a first memory coupled to the first processor, providing a first storage area which stores the data, and including a second storage area which stores a replication of the data stored in the first storage area,
the management computer having a second interface coupled to the storage subsystem, a second processor coupled to the second interface, and a second memory coupled to the second processor,
the data management method comprising the steps of:
replicating, by the first processor, when the data stored in the first storage area is to be updated, unupdated data to the second storage area before updating the data;
sending, by the second processor, upon reception of a request to erase the data stored in the first storage area, the request to erase the data stored in the first storage area to the storage subsystem;
suspending, by the first processor, replication of the unupdated data to the second storage area upon reception of the request to erase the data stored in the first storage area; and
erasing, by the first processor, the data stored in the first storage area based on the request to erase the data.

15. The data management method according to claim 14, further comprising the step of erasing, by the first processor, after suspending the replication of the data stored in the first storage area to the second storage area, data stored in the second storage area corresponding to the first storage area.

16. The data management method according to claim 15, further comprising the step of erasing, by the first processor, the data stored in the first storage area and the data stored in the second storage area by overwriting the first storage area and the second storage area with given dummy data a plurality of times.

17. The data management method according to claim 16, further comprising the step of outputting, by the second processor, when the erasing the data stored in the first storage area and the data stored in the second storage area is completed, a notification that the data stored in the first storage area and the data stored in the second storage area have been erased.

18. The data management method according to claim 15, further comprising the step of preventing, by the first processor, when the second storage area corresponding to the first storage area further corresponds to first storage areas other than the first storage area from which the data is requested to be erased, erasure of the data stored in the second storage area.

19. The data management method according to claim 14, further comprising the step of resuming, by the first processor, after erasing the data stored in the first storage area, the replication of the unupdated data to the second storage area.

20. The data management method according to claim 14,
wherein the computer system manages information on correspondence between the data stored in the first storage area and the data replicated to the second storage area on a generation basis, and
wherein the data management method further comprises the step of deleting, by the first processor, when the data of a selected generation replicated to the second storage area is to be erased, an entry for data of the generation to be erased from the information on correspondence.
